(19) United States
(12) Patent Application Publication
(10) Pub. No.: US 2025/0147816 A1
(43) Pub. Date: May 8, 2025

(54) AUTOMATED DISTRIBUTION OF PROCESSING NODES OF A RULES-BASED APPLICATION ACROSS MULTIPLE COMPUTE INSTANCES

(71) Applicant: Red Hat, Inc., Raleigh, NC (US)

(72) Inventors: Edoardo Vacchi, Milan (IT); Paolo Antinori, Milan (IT)

(21) Appl. No.: 18/502,529

(22) Filed: Nov. 6, 2023

(51) Int. Cl. G06F 9/50; G06N 5/01

(52) U.S. Cl. CPC G06F 9/5072; G06F 9/5077; G06N 5/01

(57) ABSTRACT

A Rete decision tree that identifies a plurality of nodes that correspond to conditions identified in a rules-based application and a plurality of paths through subsets of the nodes in accordance with logic of the rules-based application is accessed. The Rete decision tree is partitioned into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition. A first service that implements the first partition is caused to be initiated on a first compute instance and a second service that implements the second partition is caused to be initiated on a second compute instance.

### BACKGROUND

A rules engine is a software system that executes a rules-based application made up of a plurality of rules. The rules typically include one or more conditions and an action that is taken based on the outcome of the conditions. Complex rules-based application can include hundreds or even thousands of rules.

### SUMMARY

The examples disclosed herein implement automated partitioning of processing nodes of a rules-based application for execution by a rules engine.

In one implementation a method is provided. The method includes accessing, by a computing system comprising a computing device, a Rete decision tree that identifies a plurality of nodes that correspond to conditions identified in a rules-based application and a plurality of paths through subsets of the nodes in accordance with logic of the rules-based application. The method further includes partitioning, by the computing system, the Rete decision tree into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition. The method further includes causing, by the computing system, a first service that implements the first partition to be initiated on a first compute instance and a second service that implements the second partition to be initiated on a second compute instance.

In another implementation a computing system is provided. The computing system includes one or more computing devices to access a Rete decision tree that identifies a plurality of nodes that correspond to conditions identified in a rules-based application and a plurality of paths through subsets of the nodes in accordance with logic of the rules-based application. The one or more computing devices are further to partition the Rete decision tree into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition. The one or more computing devices are further to cause a first service that implements the first partition to be initiated on a first compute instance and a second service that implements the second partition to be initiated on a second compute instance.

In another implementation a non-transitory computer-readable storage medium is provided. The non-transitory computer-readable storage medium includes executable instructions to cause one or more computing devices to access a Rete decision tree that identifies a plurality of nodes that correspond to conditions identified in a rules-based application and a plurality of paths through subsets of the nodes in accordance with logic of the rules-based application. The instructions further cause the one or more computing devices to partition the Rete decision tree into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition. The instructions further cause the one or more computing devices to cause a first service that implements the first partition to be initiated on a first compute instance and a second service that implements the second partition to be initiated on a second compute instance.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1C are block diagrams of an environment in which automated distribution of processing nodes of a rules-based application across multiple compute instances can be practiced according to some implementations;

FIG. 2 is a flowchart of a method for automated distribution of processing nodes of a rules-based application across multiple compute instances according to some implementations;

FIG. 3 is a diagram illustrating a user interface presenting a plurality of solutions for automated distribution of processing nodes of a rules-based application across multiple compute instances according to one implementation;

FIG. 4 is a simplified block diagram of the environment illustrated in FIGS. 1A-1C according to one implementation; and

FIG. 5 is a block diagram of a computing device suitable for automated distribution of processing nodes of a rules-based application across multiple compute instances can be practiced according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A rules engine is a software system that executes a rules-based application made up of a plurality of rules. The rules typically include one or more conditions and an action that is taken based on the outcome of the conditions. Complex rules-based application can include hundreds or even thousands of rules.

Many rules engines operate in accordance with the Rete algorithm designed by Dr. Charles Forgy. The Rete algorithm is a pattern matching algorithm for implementing rule-based systems. The algorithm was developed to efficiently apply many rules or patterns to many objects, or facts, in a knowledge base.

A Rete-based rules engine receives as input one or more specifications written in a predetermined syntax that identifies the rules and the relationship between the rules, such as an order of operation of the rules. A complex rules-based engine may implement hundreds or thousands of rules, and many of the rules may be interrelated to one another, such that they share some of the same conditions.

The rules engine typically processes the specification to generate a Rete decision tree (sometimes referred to as a Rete graph, Rete network, or Rete discrimination tree), typically an acyclic directed graph wherein nodes of the graph correspond to conditions or actions and edges between nodes identify execution flow. Many of the nodes in the Rete decision tree correspond to conditions, and an identical condition that is in several different rules may be represented by a single node, vastly increasing the efficiency of determining which rule, if any, a particular transaction meets. A complete rule may be represented by a certain path through the nodes of the Rete decision tree such that if each condition corresponding to a node in the path of nodes is met by an input transaction, an action is taken. The Rete decision tree identifies the paths through the nodes via edges between the nodes.

The rules engine also typically generates processing node segments that correspond to the nodes in the Rete decision tree, and which, when executed by a computing device, implement the corresponding node of the Rete decision tree. Running instances of the processing node segments will be referred to herein as “processing nodes” and at least some of the processing nodes implement conditional statements that operate on “facts”. The facts are introduced into the rules-based application via a “fact object” that contains factual information relating to a transaction that is submitted to the rules-based application. If the facts in the fact object meet a condition the fact object is passed down to the next processing node. If a fact object reaches the end of the path then the fact object met each condition and an action is taken. The fact objects and outcomes of any actions may be stored in a working memory that is accessed by the processing nodes.

Rules engines generally process input facts more quickly than other programming techniques that rely on sequential processing of nested IF-THEN-ELSE statements. A Rete decision tree grows with the number of rules of the rules-based application, and thus a large set of rules results in a large Rete decision tree and a corresponding large number of processing nodes. Typically a rules engine executes a rules-based application on a single compute instance (e.g., a bare metal machine or a virtual machine). However, it may be desirable to distribute the processing nodes across multiple compute instances, and, for resource-constrained computing devices, such as Internet-of-Things (IoT) devices, it may not be possible to load a large rules-based application in the limited memory of such devices.

The examples disclosed herein implement automated partitioning of processing nodes of a rules-based application for execution by a rules engine in a manner that does not duplicate paths. In particular, the examples disclosed herein access a Rete decision tree that identifies a plurality of nodes that correspond to conditions identified in a rules-based application and a plurality of paths through subsets of the nodes in accordance with logic of the rules-based application. The rules engine partitions the Rete decision tree into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition. The rules engine causes a first service that implements the first partition to be initiated on a first compute instance and a second service that implements the second partition to be initiated on a second compute instance.

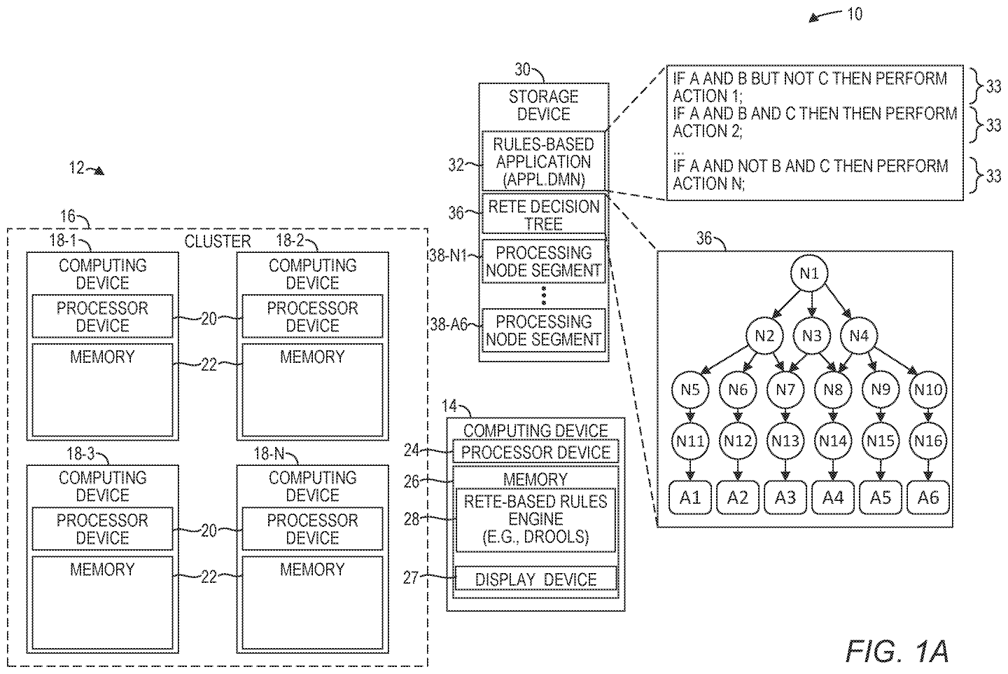

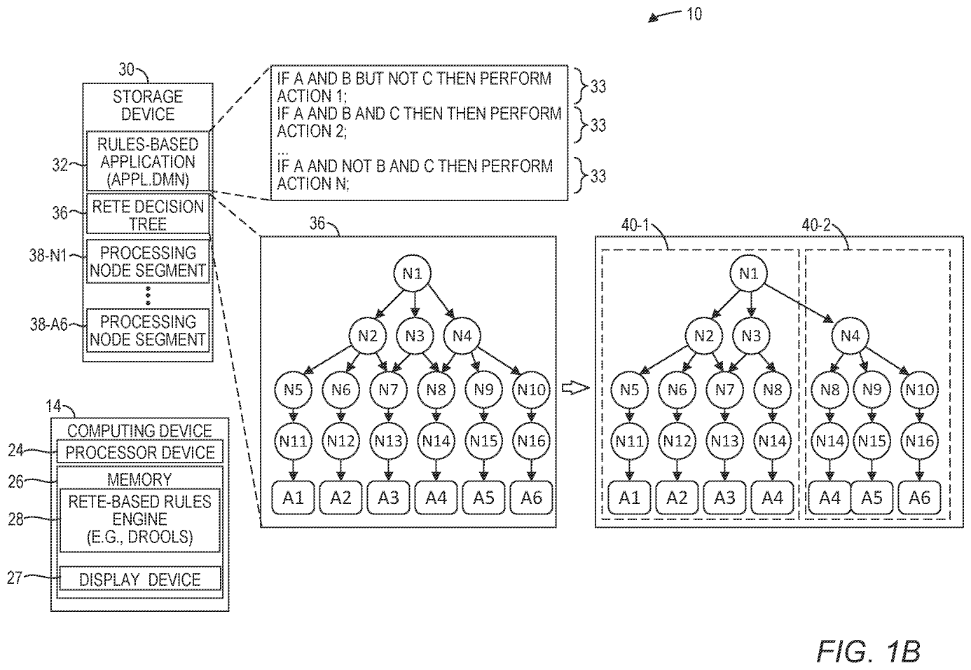

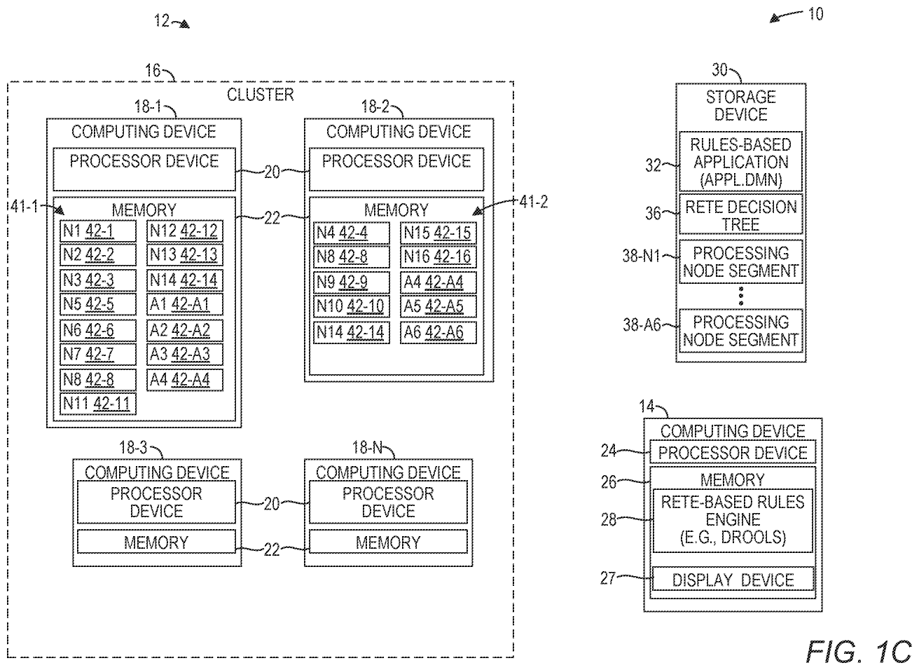

FIG. 1A is a block diagram of an environment 10 in which automated distribution of processing nodes of a rules-based application across multiple compute instances can be practiced according to some implementations. The environment 10 includes a computing system 12 that includes one or more computing devices 14 and a cluster 16 of compute instances, in this example computing devices 18-1-18-N (generally, computing devices 18). The term “compute instance” as used herein refers to a processing unit, such as a computing device, a virtual machine, a processor device, or the like. While for purposes of illustration the compute instances disclosed herein are computing devices, in other implementations the compute instances may comprise virtual machines, or even individual processor devices on the same computing device. The cluster 16 may be any type of computing cluster such as, by way of non-limiting example, a Kubernetes cluster or an Amazon Lambda cluster. Each of the computing devices 18 includes a processor device 20 and a memory 22.

The computing device 14 includes a processor device 24, a memory 26 and a display device 27. A Rete-based rules engine 28 (hereinafter “rules engine 28” for the sake of brevity) executes in the memory 26. The term “Rete-based rules engine” refers to any rules engine that processes one or more specification files that compose (e.g., define) a rules-based application and identify a plurality of conditions and actions taken in response to the conditions, and that organizes the conditions into a Rete network (sometimes referred to as a Rete decision tree) for executing the rules-based application. The examples disclosed herein have applicability to any such Rete-based rules engine, however, in one implementation, the rules engine 28 comprises Drools, available at drools.org, modified as described herein.

The computing device 14 includes or is communicatively coupled to a storage device 30 on which a rules-based application 32 is stored. The rules-based application 32 comprises a plurality of rules 33, each of which includes one or more conditions and an action that may be taken based on an evaluation of the one or more conditions, and is written in a specific syntax such as, by way of non-limiting example, decision model and notation (DMN) syntax. The rules engine 28 generates, based on the rules-based application 32, a Rete decision tree 36 that identifies nodes N1-N16 and A1-A6. The nodes N1-N16 correspond to conditions identified in the rules 33 and arrows (e.g., edges) extending from one node N1-N16 to another node N1-N16 identify a particular combination of conditions associated with one or more rules. The nodes A1-A6 correspond to different actions that will be taken if the conditional evaluations lead to that particular node A1-A6. As will be discussed in greater detail herein, the rules engine 28 will cause processing nodes that implement the logic that corresponds to the nodes N1-N16 and A1-A6 to be initiated on the cluster 16.

As an example of how the processing nodes implement a rule 33, if a particular “fact object” (e.g., a transaction) that is inserted at the node N1 contains information that causes the conditional evaluations along the path of the subset of processing nodes that correspond to the subset of nodes N1, N2, N5 and N11 to each be true, then the processing node that corresponds to the node A1 will implement a particular action. If the particular fact object contains information that causes the conditional evaluations along the path of the subset of processing nodes that correspond to the subset of nodes N1, N2, N6 and N12 to each be true, then the processing node that corresponds to the node A2 will implement a particular action.

The rules engine 28 accesses the rules-based application 32 and generates a plurality of processing node segments 38-N1-38-A6 that correspond to the nodes N1-N16 and A1-A6 and that comprise executable instructions that, when executed on a computing device 18, implement the logic of the corresponding node N1-N16 and A1-A6. For example the processing node segment 38-N1 may correspond to the node N1. Assume that the rules-based application 32 expects one of three different types of fact objects to be presented to the node N1. The node N1 is a root node that causes execution to continue along a path to one of the children nodes N2, N3 or N4, depending on the particular type of fact object presented to the node N1. The processing node segment 38-N1 thus, when executed, identifies the type of particular fact object that is being input into the rules-based application 32, and depending on the type of fact object, routes the fact object to a processing node segment 38 that corresponds to the node N2, N3 or N4 depending on the type of fact object.

Referring now to FIG. 1B, the rules engine 28 partitions the Rete decision tree 36 into at least two partitions 40-1 and 40-2 such that once the root node N1 passes a fact object to a child node N2, N3 or N4, the processing of the fact object takes place entirely in a particular partition. In this example, the partition 40-1 comprises a first plurality of nodes N1, N2, N3, N5-N8, N11-N14 and A1-A4, and a set of paths N1, N2, N5, N11 and A1; N1, N2, N6, N12 and A2; N1, N2, N7, N13 and A3; N1, N3, N7, N13 and A3; and N1, N3, N8, N14 and A4. The partition 40-2 comprises a second plurality of nodes N4, N8-N10, N14-N16 and A4-A6, and a set of paths N4, N8, N14 and A4; N4, N9, N15 and A5; and N4, N10, N16 and A6. Note that the nodes N8, N14 and A4 are duplicated in both of the partitions 40-1 and 40-2, and that no path in the partition 40-1 is duplicated in the partition 40-1.

Referring now to FIG. 1C, the rules engine 28 causes a first service 41-1 that implements the partition 40-1 to be initiated on the computing device 18-1 and a second service 41-2 that implements the partition 40-2 to be initiated on the computing device 18-2. The rules engine 28 implements the first service 41-1 by causing the instantiation of processing nodes 42-1-42-8, 42-11-42-14 and 42-A1-42-A4 from the processing node segments 38 that correspond to the nodes N1-N8, N11-N14 and A1-A4, respectively. In some implementations the processing nodes 42-1-42-8, 42-11-42-14 and 42-A1-42-A4 may be implemented as separate processes. In one implementation, the processing nodes 42-1-42-8, 42-11-42-14 and 42-A1-42-A4 are instantiated as a Linux container. In another implementation the processing nodes 42-1-42-8, 42-11-42-14 and 42-A1-42-A4 are instantiated as individual Linux containers. In another implementation, one or more of the processing nodes 42-1-42-8, 42-11-42-14 and 42-A1-42-A4 may be implemented as serverless functions.

The rules engine 28 implements the second service 41-2 by causing the instantiation of processing nodes 42-4, 42-8-42-10, 42-14-42-16 and 42-A4-42-A6 from the processing node segments 38 that correspond to the nodes N4, N8-N10, N14-N16 and A4-A6, respectively. Again, the processing nodes 42-4, 42-8-42-10, 42-14-42-16 and 42-A4-42-A6 may be instantiated in a single container, as individual containers, and/or as serverless functions. Note that the processing nodes 42-8, 42-14 and 42-A4 are duplicated in the services 42-1 and 42-2 and implement identical logic, but are utilized in different paths.

In practice, when a fact object is inserted into the root processing node 42-1, the root processing node 42-1 determines the type of fact object and, where the type of fact object corresponds to the type of fact object processed by the processing node 42-4, routes the fact object to the processing node 42-4 on the computing device 18-2 utilizing a suitable inter-computing device communication mechanism, such as a message bus, a queue, or the like. Where the type of fact object corresponds to the type of fact object processed by the processing nodes 42-2 or 42-3, the root processing node 42-1 routes the fact object to the processing nodes 42-2 or 42-3. The routing logic implemented by the root processing node 42-1 may be generated and inserted into the root processing node segment 38-N1 by the rules engine 28. In particular, the rules engine 28 may generate the root processing node segment 38-N1 to include executable instructions that cause the root processing node 42-1 to determine on which computing device 18 each of the children processing nodes 42-2, 42-3 and 42-4 reside, and to route the fact object to the appropriate processing node 42-2, 42-3 or 42-4.

It is noted that, because the rules engine 28 is a component of the computing device 14, functionality implemented by the rules engine 28 may be attributed to the computing device 14 generally. Moreover, in examples where the rules engine 28 comprises software instructions that program the processor device 24 to carry out functionality discussed herein, functionality implemented by the rules engine 28 may be attributed herein to the processor device 24.

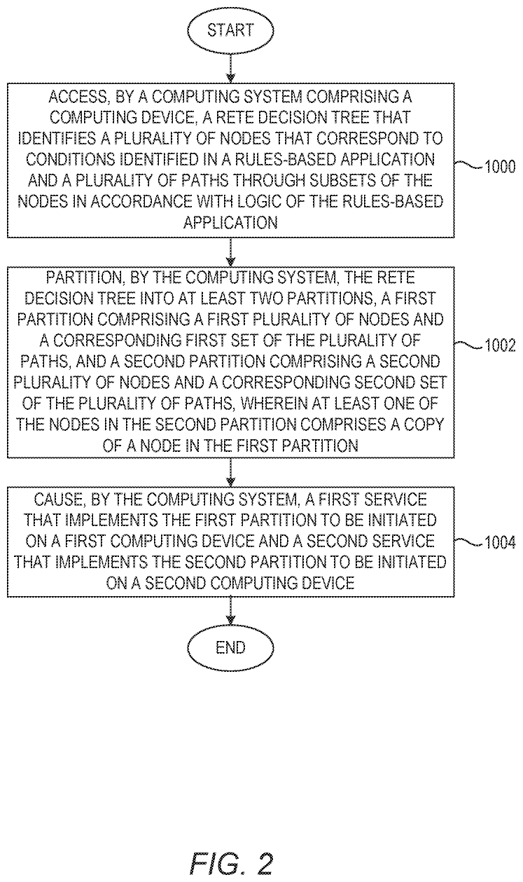

FIG. 2 is a flowchart of a method for automated distribution of processing nodes of a rules-based application across multiple compute instances according to some implementations. FIG. 2 will be discussed in conjunction with FIGS. 1A-1C. The computing device 14 accesses the Rete decision tree 36 that identifies the plurality of nodes N1-N16 that correspond to conditions identified in the rules-based application 32 and the plurality of paths through subsets of the nodes N1-N16 in accordance with logic of the rules-based application 32 (FIG. 2, block 1000). The computing device 14 partitions the Rete decision tree 36 into the at least two partitions 40-1 and 40-2, the partition 40-1 comprising the plurality of nodes N1, N2, N3, N5-N8, N11-N14 and A1-A4, and the corresponding set of the plurality of paths N1, N2, N5, N11 and A1; N1, N2, N6, N12 and A2; N1, N2, N7, N13 and A3; N1, N3, N7, N13 and A3; and N1, N3, N8, N14 and A4, and the partition 40-2 comprising the plurality of nodes N4, N8-N10, N14-N16 and A4-A6, and a corresponding second set of the plurality of paths N4, N8, N14 and A4; N4, N9, N15 and A5; and N4, N10, N16 and A6, wherein at least one of the nodes N8 in the partition 40-2 comprises a copy of the node N8 in the partition 40-1 (FIG. 2, block 1002). The computing device 14 causes the service 41-1 that implements the partition 40-1 to be initiated on the computing device 18-1 and the service 41-2 that implements the partition 40-2 to be initiated on the computing device 18-2 (FIG. 2, block 1004).

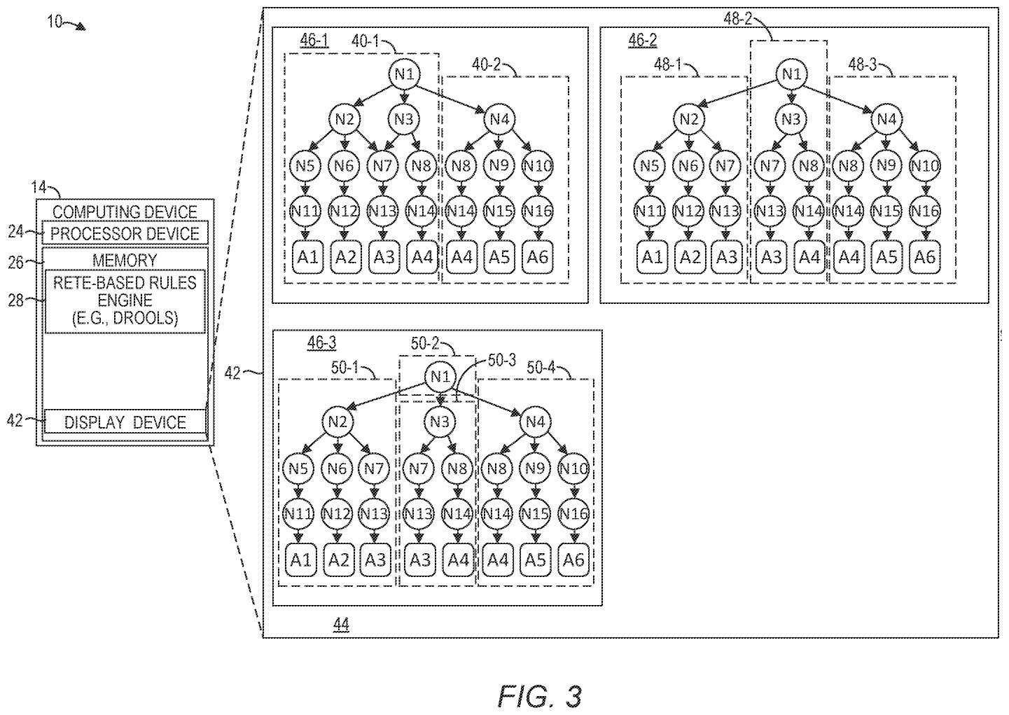

In some implementations the rules engine 28 may generate multiple possible partitioning solutions, and present, on the display device 27, user interface imagery that identifies the plurality of partitioning solutions. FIG. 3 is a diagram illustrating user interface imagery 44 presenting a plurality of partitioning solutions for automated distribution of the processing nodes 42-1-42-A6 of the rules-based application 32 across the cluster of computing devices 18 according to one implementation. In this example, the rules engine 28 derived three possible partitioning solutions 46-1-46-3. The rules engine 28 generates the user interface imagery 44 that visually identifies the three solutions 46-1-46-3 and presents the user interface imagery 44 on the display device 27.

The user interface imagery 44 includes the solution 46-1 presented in FIG. 3, above. The user interface imagery 44 also includes a solution 46-2 that proposes three partitions, a partition 48-1 that comprises a first plurality of nodes N2, N5-N7, N11-N13, and A1-A3, a partition 48-2 that comprises a second plurality of nodes N1, N3, N7-N8, N13-N14, and A3-A4, and a partition 48-3 that comprises a third plurality of nodes N4, N8-N10, N14-N16, and A4-A6. Note that nodes N7, N13 and A3 are duplicated in partitions 50-1 and 50-2 and nodes N8, N14 and A4 are duplicated in partitions 50-3 and 50-40 so that once the root processing node N1 passes a fact object to a particular partition the processing of the fact object need not be communicated back and forth between the computing devices 18.

The user interface imagery 44 also includes a solution 46-3 that proposes four partitions, a partition 50-1 that comprises the root processing node N1, a partition 50-2 that comprises the nodes N2, N5-N7, N11-N13, and A1-A3, a partition 50-3 that comprises the nodes N3, N7-N8, N13-N14, and A3-A4, and a partition 50-4 that comprises the nodes N4, N8-N10, N14-N16, and A4-A6. Again, note that nodes N7, N13 and A3 are duplicated in partitions 48-1 and 48-2 and nodes N8, N14 and A4 are duplicated in partitions 48-2 and 48-3 so that once the root processing node N1 passes a fact object to a particular partition the processing of the fact object need not be communicated back and forth between the computing devices 18.

A user, such as an operator, may review the multiple solutions 46-1-46-3 and select a particular solution 46-1-46-3. The rule engine 28 receives the selection of the solution, and causes a corresponding service comprising the processing nodes 42 associated with each partition to be initiated on a particular computing device 18 such that each partition is implemented on a different computing device 18.

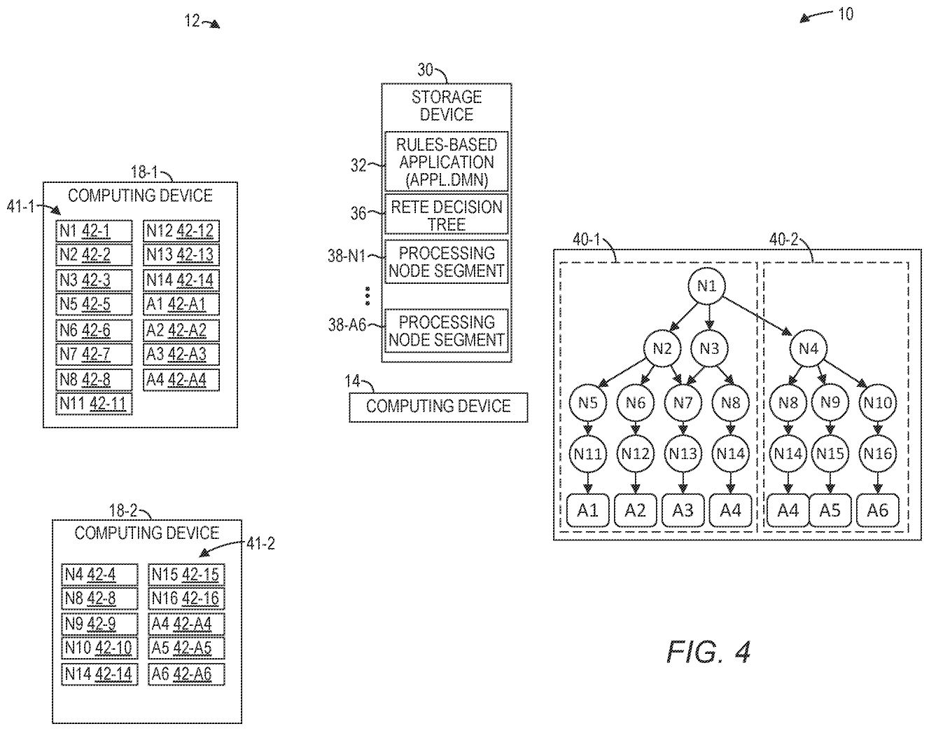

FIG. 4 is a simplified block diagram of the environment 10 illustrated in FIGS. 1A-1C according to one implementation. The environment 10 includes the computing device 14. The computing device 14 accesses the Rete decision tree 36 that identifies the plurality of nodes N1-N16 that correspond to conditions identified in the rules-based application 32 and the plurality of paths through subsets of the nodes N1-N16 in accordance with logic of the rules-based application 32. The computing device 14 partitions the Rete decision tree 36 into the at least two partitions 40-1 and 40-2, the partition 40-1 comprising the plurality of nodes N1, N2, N3, N4, N5-N8, N11-N14 and A1-A4, and the corresponding set of the plurality of paths N1, N2, N5, N11 and A1; N1, N2, N6, N12 and A2; N1, N2, N7, N13 and A3; N1, N3, N7, N13 and A3; and N1, N3, N8, N14 and A4, and the partition 40-2 comprising the plurality of nodes N4, N8-N10, N14-N16 and A4-A6, and a corresponding second set of the plurality of paths N4, N8, N14 and A4; N4, N9, N15 and A5; and N4, N10, N16 and A6, wherein at least one of the nodes N8 in the partition 40-2 comprises a copy of the node N8 in the partition 40-1. The computing device 14 causes the service 41-1 that implements the partition 40-1 to be initiated on the computing device 18-1 and the service 41-2 that implements the partition 40-2 to be initiated on the computing device 18-2.

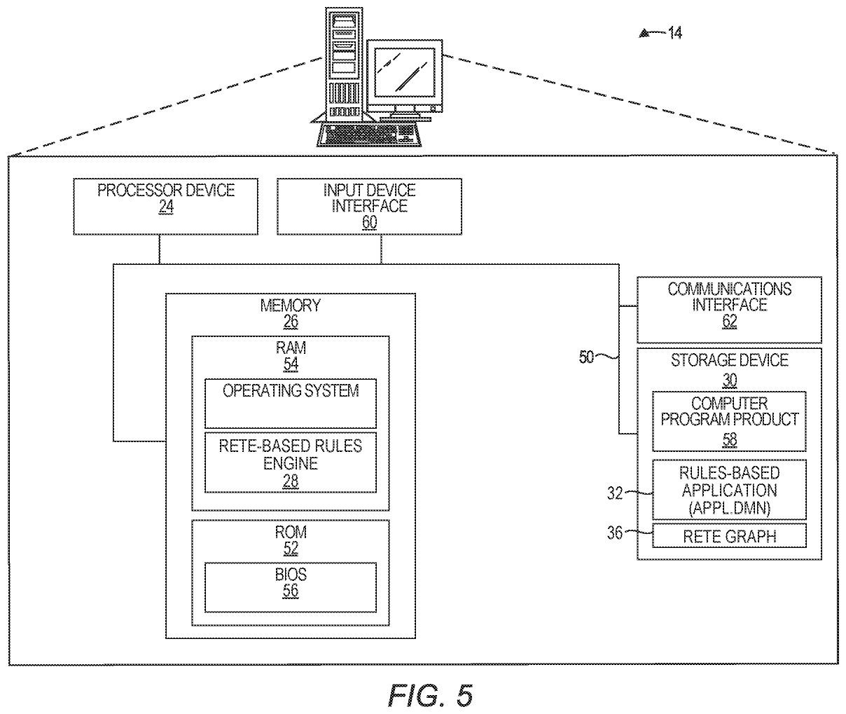

FIG. 5 is a block diagram of the computing device 14 suitable for implementing examples according to one example. The computing device 14 may comprise any computing or electronic device capable of including firmware, hardware, and/or executing software instructions to implement the functionality described herein, such as a computer server, a desktop computing device, a laptop computing device, or the like. The computing device 14 includes the processor device 24, the system memory 26, and a system bus 50. The system bus 50 provides an interface for system components including, but not limited to, the system memory 26 and the processor device 24. The processor device 24 can be any commercially available or proprietary processor device.

The system bus 50 may be any of several types of bus structures that may further interconnect to a memory bus (with or without a memory controller), a peripheral bus, and/or a local bus using any of a variety of commercially available bus architectures. The system memory 26 may include non-volatile memory 52 (e.g., read-only memory (ROM), erasable programmable read-only memory (EPROM), electrically erasable programmable read-only memory (EEPROM), etc.), and volatile memory 54 (e.g., random-access memory (RAM)). A basic input/output system (BIOS) 56 may be stored in the non-volatile memory 52 and can include the basic routines that help to transfer information between elements within the computing device 14. The volatile memory 54 may also include a high-speed RAM, such as static RAM, for caching data.

The computing device 14 may further include or be coupled to a non-transitory computer-readable storage medium such as the storage device 30, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 30 and other drives associated with computer-readable media and computer-usable media may provide non-volatile storage of data, data structures, computer-executable instructions, and the like.

A number of modules can be stored in the storage device 30 and in the volatile memory 54, including an operating system and one or more program modules, such as the rules engine 28, which may implement the functionality described herein in whole or in part. All or a portion of the examples may be implemented as a computer program product 58 stored on a transitory or non-transitory computer-usable or computer-readable storage medium, such as the storage device 30, which includes complex programming instructions, such as complex computer-readable program code, to cause the processor device 24 to carry out the steps described herein. Thus, the computer-readable program code can comprise software instructions for implementing the functionality of the examples described herein when executed on the processor device 24. The processor device 24, in conjunction with the rules engine 28 in the volatile memory 54, may serve as a controller, or control system, for the computing device 14 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 24 through an input device interface 60 that is coupled to the system bus 50 but can be connected by other interfaces such as a parallel port, an Institute of Electrical and Electronic Engineers (IEEE) 1394 serial port, a Universal Serial Bus (USB) port, an IR interface, and the like. The computing device 14 may also include a communications interface 62 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
accessing, by a computing system comprising a computing device, a Rete decision tree that identifies a plurality of nodes that correspond to conditions identified in a rules-based application and a plurality of paths through subsets of the nodes in accordance with logic of the rules-based application;
partitioning, by the computing system, the Rete decision tree into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition; and
causing, by the computing system, a first service that implements the first partition to be initiated on a first compute instance and a second service that implements the second partition to be initiated on a second compute instance.

2. The method of claim 1, further comprising generating, by the computing system, the Rete decision tree from the rules-based application.

3. The method of claim 1, wherein no path in the first partition implements a same logic as any path in the second partition.

4. The method of claim 1, wherein the first service comprises a first plurality of processing nodes that corresponds to the first plurality of nodes and the second service comprises a second plurality of processing nodes that corresponds to the second plurality of nodes.

5. The method of claim 1, wherein the first service is implemented in a container.

6. The method of claim 1, wherein causing, by the computing system, the first service that implements the first partition to be initiated on the first computing device comprises causing an initiation of a plurality of processing nodes on the first computing device, each processing node of the plurality of processing nodes corresponding to a node in the first partition.

7. The method of claim 6, wherein the processing nodes are implemented as serverless functions.

8. The method of claim 6, further comprising:
generating, by the computing system, a plurality of processing node segments based on the rules-based application, and wherein the processing nodes are initiated from corresponding processing node segments.

9. The method of claim 1, further comprising:
generating, by the computing system, a root processing node segment operative to route a fact object to one of the first computing device or the second computing device based on a type of the fact object.

10. A computing system comprising:
one or more computing devices to:
access a Rete decision tree that identifies a plurality of nodes that correspond to conditions identified in a rules-based application and a plurality of paths through subsets of the nodes in accordance with logic of the rules-based application,
partition the Rete decision tree into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition; and
cause a first service that implements the first partition to be initiated on a first compute instance and a second service that implements the second partition to be initiated on a second compute instance.

11. The computing system of claim 10, wherein the one or more computing devices are further to generate the Rete decision tree from the rules-based application.

12. The computing system of claim 10, wherein no path in the first partition implements a same logic as any path in the second partition.

13. The computing system of claim 10, wherein the first service comprises a first plurality of processing nodes that corresponds to the first plurality of nodes and the second service comprises a second plurality of processing nodes that corresponds to the second plurality of nodes.

14. The computing system of claim 10, wherein the first service is implemented in a container.

15. The computing system of claim 10, wherein to cause the first service that implements the first partition to be initiated on the first computing device, the one or more computing devices are further to cause an initiation of a plurality of processing nodes on the first computing device, each processing node of the plurality of processing nodes corresponding to a node in the first partition.

16. The computing system of claim 15, wherein the one or more computing devices are further to generate a plurality of processing node segments based on the rules-based application, and wherein the processing nodes are initiated from corresponding processing node segments.

17. A non-transitory computer-readable storage medium that includes executable instructions to cause one or more computing devices to:
access a Rete decision tree that identifies a plurality of nodes that correspond to conditions identified in a rules-based application and a plurality of paths through subsets of the nodes in accordance with logic of the rules-based application;
partition the Rete decision tree into at least two partitions, a first partition comprising a first plurality of nodes and a corresponding first set of the plurality of paths, and a second partition comprising a second plurality of nodes and a corresponding second set of the plurality of paths, wherein at least one of the nodes in the second partition comprises a copy of a node in the first partition; and
cause a first service that implements the first partition to be initiated on a first compute instance and a second service that implements the second partition to be initiated on a second compute instance.

18. The non-transitory computer-readable storage medium of claim 17, wherein no path in the first partition implements a same logic as any path in the second partition.

19. The non-transitory computer-readable storage medium of claim 17, wherein the first service comprises a first plurality of processing nodes that corresponds to the first plurality of nodes and the second service comprises a second plurality of processing nodes that corresponds to the second plurality of nodes.

20. The non-transitory computer-readable storage medium of claim 17, wherein to cause the first service that implements the first partition to be initiated on the first computing device, the instructions further cause the one or more computing devices to cause an initiation of a plurality of processing nodes on the first computing device, each processing node of the plurality of processing nodes corresponding to a node in the first partition.
